(19) United States
(12) Patent Application Publication
(10) Pub. No.: US 2008/0095908 A1
(43) Pub. Date: Apr. 24, 2008

(54) Baking cup with fill line

(75) Inventors: Lynn Vendl, Woodridge, IL (US); Lou Henry, New York, NY (US)

Correspondence Address: PATENT GROUP;C/O DLA PIPER US LLP, 203 N. LASALLE ST., SUITE 1900, CHICAGO, IL, 60601, US

(73) Assignee: WILTON INDUSTRIES, INC.

(21) Appl. No.: 11/584,107

(22) Filed: Oct. 20, 2006

(51) Int. Cl. A21D 10/00

(52) U.S. Cl. 426/549

(57) ABSTRACT

A baking cup features a corrugated sidewall and a base. The interior surface of the side wall is provided with a fill line spaced from the top edge of the sidewall. When the baking cup is filled with batter to the fill line, a resulting baked cupcake or other food item will have a desired predetermined height or thickness.

### FIELD OF THE INVENTION

The present invention relates generally to baking and, more particularly, to baking cup with a fill line to facilitate baking cupcakes and other food items.

### BACKGROUND OF THE INVENTION

The traditional baking pan for cupcakes is a tray with a number of cupcake depressions. The cupcake batter is poured into the depressions and the pan is placed in an oven for baking. A problem associated with using such a pan, however, is the sticking of the cupcakes to the depressions of the pan. This makes it very difficult to remove the cupcakes from the pan and very often results in breaking up of the cupcakes or the tearing away of the outer portions of the cupcakes.

These problems are alleviated by placing paper baking cups in the depressions of the tray and pouring batter into the paper cups. After baking, the paper cup and cupcake are removed from the pan as a unit. The paper cups feature sidewalls that are corrugated so that removal of the cupcakes from the paper cups is facilitated.

While paper baking cups may only be used a single time and then are discarded, baking cups may alternatively be made of high temperature, reusable materials such as silicone.

Cupcake batter expands during baking. As a result, bakers do not fill baking cups to the top with batter. If too much batter is poured into the baking cup, the batter will flow over the top of the baking cup during baking and create a mess. If too little batter is poured into the baking cup, the cupcake will not rise to the proper height. As a result, a baker must estimate what the proper fill level is for a baking cup. In addition to the problems already mentioned, this practice may also result in inconsistent cupcake thickness which damages the aesthetic appeal of the cupcakes.

A need therefore exists for baking cups that feature fill lines so that the appropriate amount of batter may be poured into the baking cups consistently and easily.

### BRIEF DESCRIPTION OF THE DRAWINGS

FIG. 1 is a top perspective view of a first embodiment of the baking cup of the present invention;

FIG. 2 is a bottom perspective view of the baking cup of FIG. 1;

FIG. 3 is a side elevational view of the baking cup of FIGS. 1 and 2;

FIG. 4 is a top plan view of the baking cup of FIGS. 1-3;

FIG. 5 is a cross sectional view of the baking cup of FIGS. 1-4 taken along line 5-5 of FIG. 4;

FIG. 6 is a top perspective view of a second embodiment of the baking cup of the present invention;

FIG. 7 is a bottom perspective view of the baking cup of FIG. 6;

FIG. 8 is a top perspective view of a third embodiment of the baking cup of the present invention;

FIG. 9 is a bottom perspective view of the baking cup of FIG. 8;

FIG. 10 is a top perspective view of a fourth embodiment of the baking cup of the present invention;

FIG. 11 is a bottom perspective view of the baking cup of FIG. 10;

FIG. 12 is a top perspective view of a fifth embodiment of the baking cup of the present invention;

FIG. 13 is a bottom perspective view of the baking cup of FIG. 12;

FIG. 14 is a top perspective view of a sixth embodiment of the baking cup of the present invention;

FIG. 15 is a bottom perspective view of the cup of FIG. 14.

### DETAILED DESCRIPTION OF EMBODIMENTS

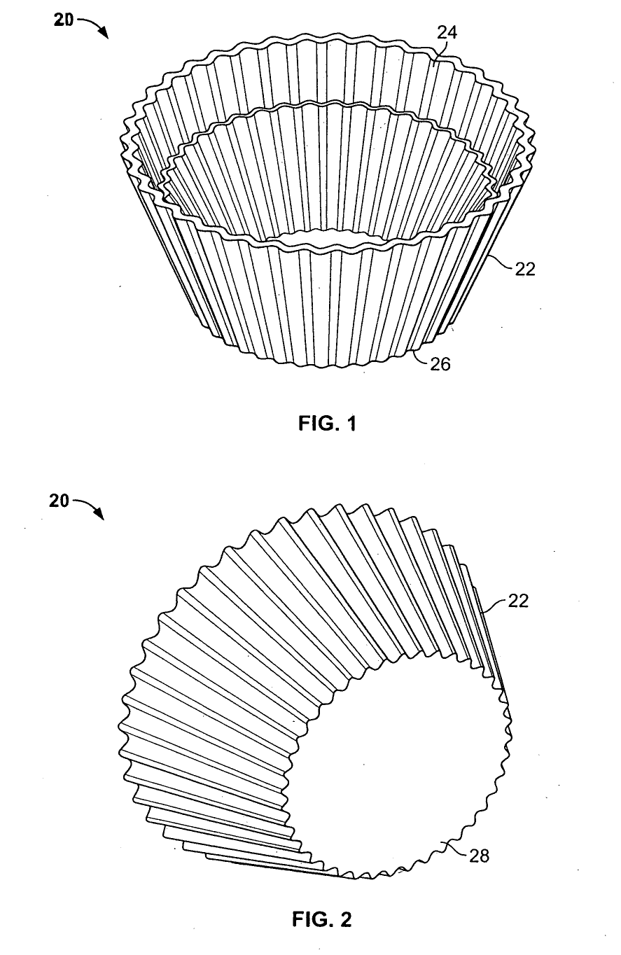

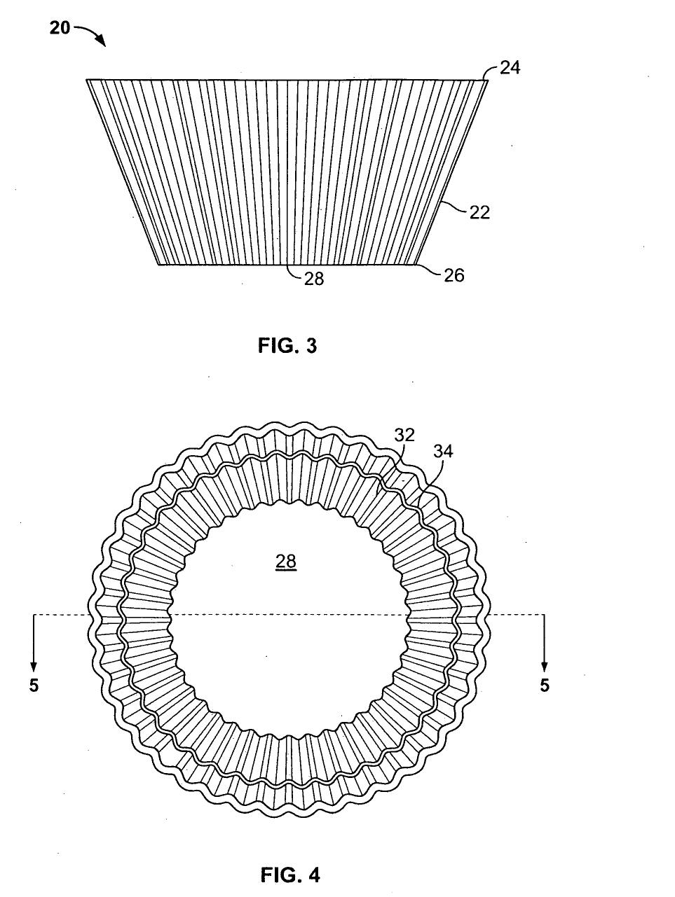

An embodiment of the baking cup of the present invention is indicated in general at 20 in FIGS. 1-3. While the baking cup 20 of FIGS. 1-3 is for baking cupcakes, it is to be understood that the present invention could be used for baking other food items.

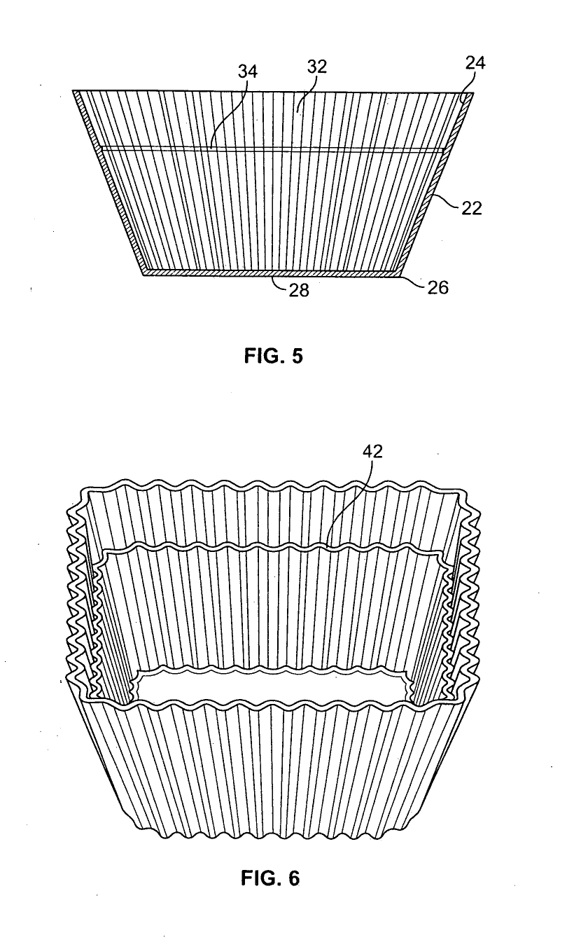

As illustrated in FIGS. 1-3, the baking cup 20 features a corrugated sidewall having a top edge 24 and a bottom edge 26 that terminates in base 28. As is illustrated in FIGS. 1, 4 and 5, the interior surface 32 of sidewall 22 is provided with a fill line 34. Fill line 34 is spaced from the top edge 24 of the sidewall so that when cupcake batter is poured into the baking cup to the level of the fill line, the top of the baked cupcake will be even with or slightly above the top edge 24 of the sidewall. In other words, filling the baking cup with batter to the level of the fill line results in the baked cupcake having a desired predetermined height or thickness. As a result, the fill line permits a baker to easily and consistently fill the baking cups of the present invention with the proper amount of cupcake batter.

The fill line 34 may be marked on the interior surface 32 of the baking cup sidewall. Alternatively, as illustrated in FIGS. 1, 4 and 5, the fill line may be molded onto or into the interior surface.

The corrugated sidewall 22 allows the baked cupcake to be easily removed from the baking cup.

The baking cup of the present invention may be constructed from virtually any high temperature and flexible material. These materials include, but are not limited to, silicone, paper and foil.

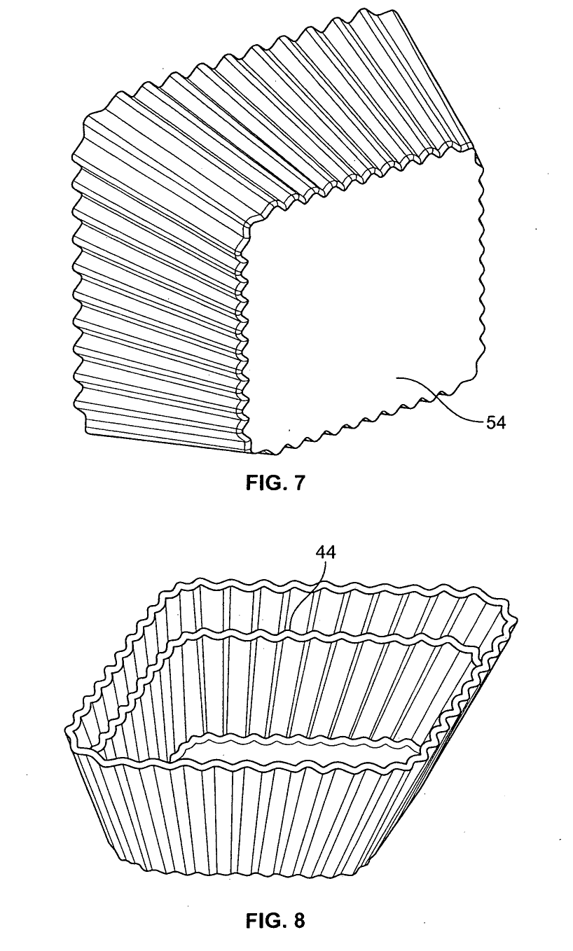

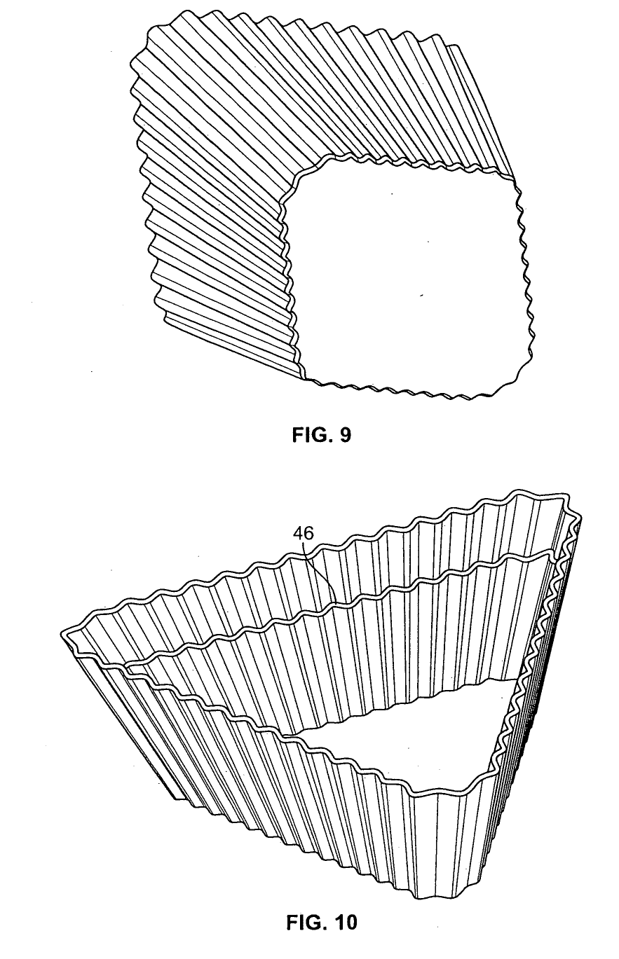

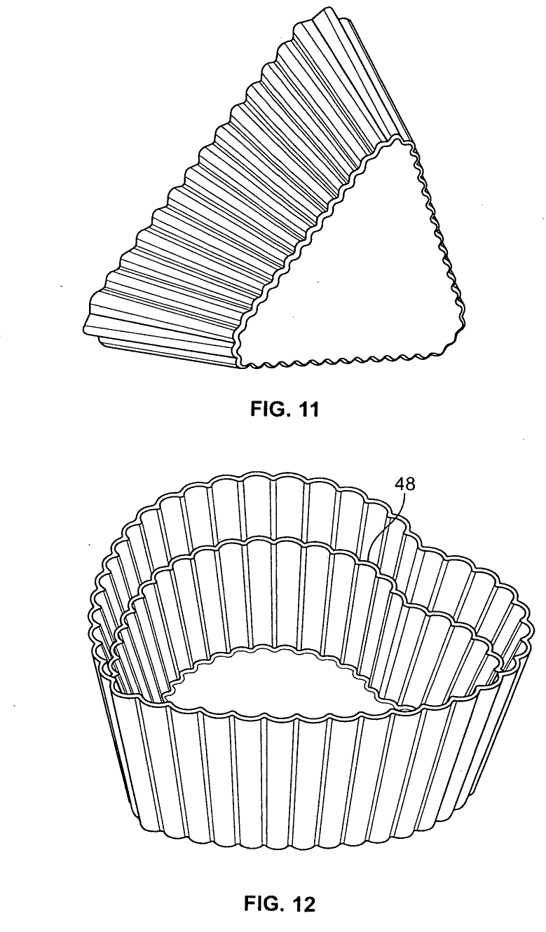

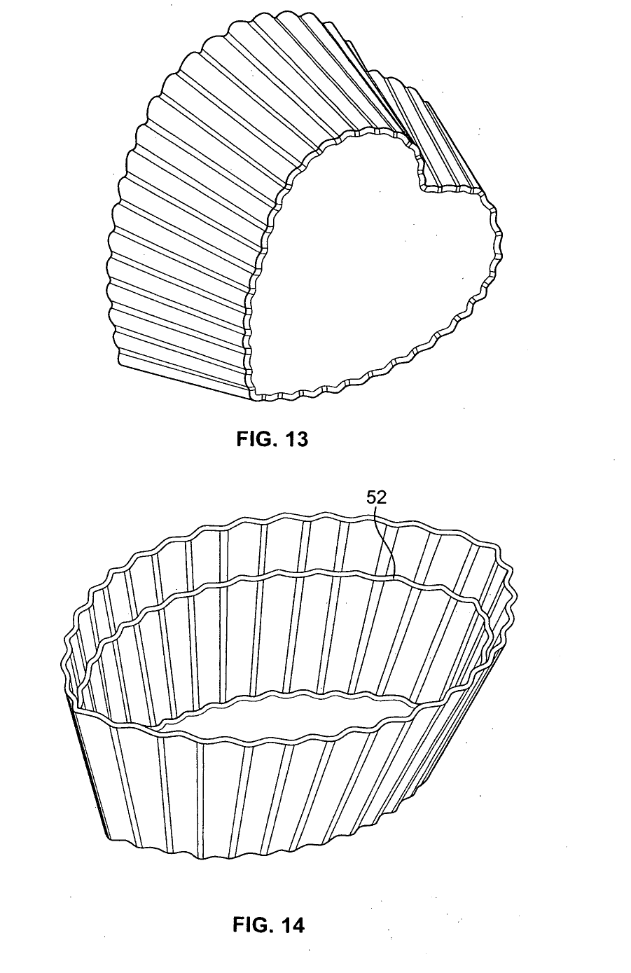

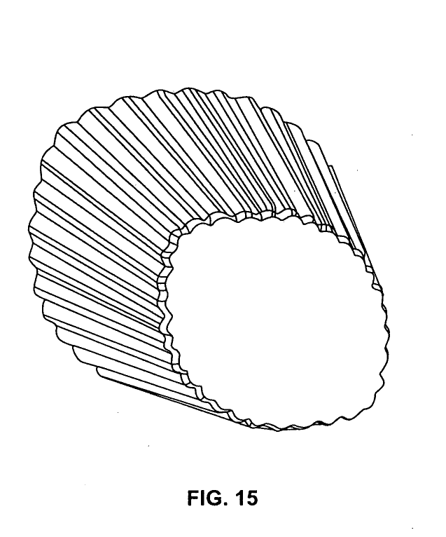

While the baking cup of FIGS. 1-5 is of the typical inverted frusto-conical shape, having a round base, baking cups of alternative shapes may be constructed in accordance with the present invention. These include baking cups having a square base, as illustrated in FIGS. 6 and 7, diamond base, as illustrated in FIGS. 8 and 9, triangular base, as illustrated in FIGS. 10 and 11, heart-shaped base, as illustrated in FIGS. 12 and 18 and novelty shapes, such as the football of FIGS. 14 and 15. The fill lines for these embodiments are illustrated at 42, 44, 46, 48 and 52 in FIGS. 6, 8, 10, 12 and 14, respectively.

As indicated at 54 in FIG. 7, each baking cup preferably includes text on the base reminding the baker to fill the cup to the fill line.

While embodiments of the invention have been shown and described, it will be apparent to those skilled in the art that changes and modifications may be made therein without departing from the spirit of the invention.

What is claimed is:

1. A baking cup for receiving and holding batter during baking comprising:
a) a sidewall having an interior surface, a top edge and a bottom edge;
b) a base joined to the sidewall near the bottom edge of the sidewall; and
c) said interior surface of the sidewall featuring a fill line spaced from the top edge so that when the baking cup is filled with batter to the fill line, a resulting baked food item will have a desired predetermined height.

2. The baking cup of claim 1 wherein the sidewall is corrugated.

3. The baking cup of claim 1 wherein the cup is made from silicone.

4. The baking cup of claim 3 wherein the fill line is molded onto the interior surface.

5. The baking cup of claim 1 wherein the cup is made from paper.

6. The baking cup of claim 5 wherein the fill line is marked on the interior surface of the sidewall.

7. The baking cup of claim 1 wherein the base features reminder text regarding the fill line.

8. The baking cup of claim 1 wherein the base is circular.

9. The baking cup of claim 1 wherein the base is square.

10. The baking cup of claim 1 wherein the base is diamond-shaped.

11. The baking cup of claim 1 wherein the base is triangular.

12. The baking cup of claim 1 wherein the base is heart-shaped.

13. The baking cup of claim 1 wherein the base is football-shaped.

14. The baking cup of claim 1 wherein the baked food item is a cupcake.

15. A method of baking a food item comprising the steps of:
a) providing a baking cup including a sidewall having an interior surface featuring a fill line;
b) filling the baking cup with batter to the fill line;
c) baking the food item; and
d) removing the baked food item from the baking cup.

16. The method of baking of claim 15 wherein the baked food item is a cupcake.

17. The method of baking of clam 15 wherein the baking cup is silicone.

18. The method of baking of claim 17 wherein the fill line is molded onto the interior surface of the sidewall.

19. The method of baking of claim 15 wherein the baking cup is paper.

20. The method of baking of claim 15 wherein the sidewall of the baking cup is corrugated to facilitate removal of the baked food item from the baking cup.
